(19) United States
(12) Patent Application Publication
(10) Pub. No.: US 2009/0272703 A1
(43) Pub. Date: Nov. 5, 2009

(54) CANDY DISPLAY STAND

(76) Inventor: W. Frederick Conway, JR., New Albany, IN (US)

Correspondence Address: BERENATO, WHITE & STAVISH, LLC, 6550 ROCK SPRING DRIVE, SUITE 240, BETHESDA, MD, 20817, US

(21) Appl. No.: 12/433,074

(22) Filed: Apr. 30, 2009

Related U.S. Application Data
(60) Provisional application No. 61/049,485, filed on May 1, 2008.

(51) Int. Cl. A47F 7/00; A47F 3/14; B28B 1/00

(52) U.S. Cl. 211/85.4; 211/133.1; 264/299

(57) ABSTRACT

A candy display stand is provided. The candy display stand includes a tray unit for holding a plurality of candy holders, and a support stand associated with the tray unit for vertically supporting a plurality of elongated candy sticks. The support stand has a base extending from the tray unit and an alignment unit extending above the base with a plurality of holding members for supporting a plurality of elongated candy sticks vertically on the base.

### CROSS-REFERENCE TO RELATED APPLICATION(S) AND CLAIM TO PRIORITY

The present application relates to U.S. Provisional Patent Application No. 61/049,485 filed Mar. 28, 2008, the contents of which are incorporated herein by reference and to which priority is claimed. Cross-reference is also made to related U.S. Utility patent application Ser. No. 12/412,712 filed Mar. 27, 2009, which claims priority to U.S. Provisional Patent Application No. 61/040,321 filed Mar. 28, 2008, the contents of both which are also incorporated herein by reference.

### FIELD OF THE INVENTION

The present invention relates to a candy display stand, a method of manufacturing a candy display stand and a method of using a candy display stand.

### BACKGROUND OF THE INVENTION

There are various types of elongated candies that people eat. For example, candy sticks or candy canes have been popular for many years. However, these candies have a tendency to become sticky when the consumer begins dissolving the candy in his or her mouth. Especially children have a tendency to make a mess when eating large elongated candy items that cannot be ingested in one bite. When the candy is consumed, particularly when by a child, the candy product may get dirty or untidy, and the consumer may become dissatisfied and throw the remaining candy away as waste.

Additionally, when entering retail outlets, consumers typically have a limited attention span and do not have time to evaluate many of the candy products offered in retail outlets. It is advantageous to display candy products in a manner which attracts the consumers' attention to the candy product and distinguishes the product from the overwhelming number of other candy products in retail outlets. Thus, there is a need for a candy display stand that attracts attention to a particular candy product, while preventing the candy from falling and breaking.

### BRIEF SUMMARY OF THE INVENTION

A first aspect of the invention involves a candy display stand comprising a tray unit having a bottom surface and a plurality of side surfaces extending therefrom and defining a holding area for holding a plurality of candy holders; and a support structure associated with the tray unit for supporting a plurality of elongated candy sticks, the support structure having a base extending from the tray unit and an alignment unit extending above the base with a plurality of support members for supporting at least one of a plurality of elongated candy sticks on the base. According to an embodiment, the candy display stand support structure is configured to support at least one of the elongated candy sticks in a substantially vertical position perpendicular to the base. According to another embodiment the candy display stand has a support structure that further includes a panel extending upward from the base and an alignment plate extending from the panel over the base, the alignment plate having a plurality of holes, each of the holes being dimensioned to fit at least one elongated candy stick. According to another embodiment the candy display support structure further includes at least one clip arranged to extend outwardly from the panel, with a sign held by the clip. In another embodiment, the panel extends vertically from the base and the alignment plate extends horizontally from the panel over the base. In another embodiment, the panel extends vertically from the base and the alignment plate extends horizontally from the panel over the base such that the base and the panel are disposed parallel to each other. In another embodiment the candy display stand comprises a plastic material, which in one embodiment is polymethylmethacrylate. In another embodiment the candy display stand involves side surfaces extending from the bottom surface of the tray unit have a side surface length that is less than a height associated with the base.

A second aspect of the invention involves candy display stand comprising a tray unit including a bottom surface and a plurality of side surfaces extending therefrom and defining a holding area; a plurality of candy holders disposed in the holding area; a support structure extending laterally from the tray unit, the support structure including a base having a plurality of bottom holes disposed at a top surface thereof, at least one panel extending upwardly from the base, and an alignment unit extending from the panel over the base, the alignment unit including an alignment plate with a plurality of upper holes, the upper holes being coaxially aligned with the lower holes; and at least one of a plurality of elongated candy sticks disposed in an aligned pair of the upper and lower holes so that the at least one candy stick extends substantially vertically from the base. In one embodiment, the support structure further includes at least one clip arranged to extend outwardly from the panel. In another embodiment, the support structure further includes a sign held by the clip. In another embodiment, the panel extends vertically from the base and the alignment plate extends horizontally from the panel over the base. In another embodiment, the panel extends vertically from the base and the alignment plate extends horizontally from the panel over the base such that the base and the alignment plate are parallel to each other. In another embodiment, the candy display stand comprises a plastic material which can be clear such as polymethylmethacrylate. In another embodiment, the side surfaces extending from the bottom surface of the tray unit have a side surface length that is less than a height associated with the base.

A third aspect of the invention involves a method of manufacturing a candy display comprising providing an amount of a molding material to a molding apparatus; performing a molding step on the molding material to form a candy display stand having as structural elements a) a tray unit for holding a plurality of candy holders and b) a support structure associated with the tray unit for supporting a plurality of elongated candy sticks, the support structure having b1) a base extending from the tray unit and b2) an alignment unit extending above the base with a plurality of support members for supporting a plurality of elongated candy sticks on the base; and removing the candy display stand from the molding apparatus. In another embodiment, the molding material is a plastic material such as polymethylmethacrylate.

A fourth aspect of the invention involves a method of using a candy display stand including a tray unit for holding one or a plurality of candy holders and a support structure associated with the tray unit for supporting one or a plurality of elongated candy sticks, the support structure having a base extending from the tray unit and an alignment unit extending above the base with a plurality of support members for supporting one or a plurality of elongated candy sticks on the base, the method comprising selecting a candy holder from the tray unit; selecting an elongated candy stick from the support stand; and inserting the selected elongated candy stick into the selected candy holder. In an optional embodiment, method involves an additional step in consuming the candy stick.

Other aspects of the invention, including the manufactured article, methods of manufacture and use, and the like which constitute part of the invention, will become more apparent upon reading the following detailed description of the exemplary embodiments and viewing the drawings.

### BRIEF DESCRIPTION OF THE DRAWINGS

FIG. 1 is a perspective view of a candy display stand according to an embodiment the present invention.

FIG. 2 is an elevational side view of the candy display stand of FIG. 1 according to an embodiment of the present invention.

FIG. 3 is an elevational side view of the candy display stand of FIG. 1, according to another embodiment of the present invention.

FIG. 4 is a top plan view of the candy display stand shown in FIG. 1.

FIG. 5 is an enlarged top view of a sign clip of the candy display stand shown in FIG. 1.

FIG. 6 is a photograph of the candy display stand in use for displaying candy sticks and candy holders according to an embodiment of the present invention.

FIG. 7 is an elevational view of a candy holder and candy stick according to an embodiment the present invention.

FIG. 8 is a perspective view of a candy display stand according to another embodiment of the present invention.

FIG. 9 is a perspective view of a candy display stand according to yet another embodiment of the present invention

### DETAILED DESCRIPTION OF THE PREFERRED EMBODIMENT(S)

Reference will now be made in detail to the embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods.

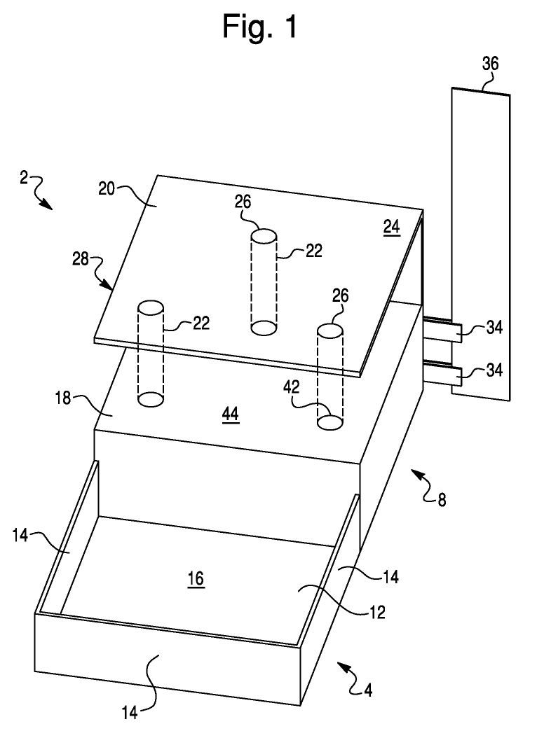

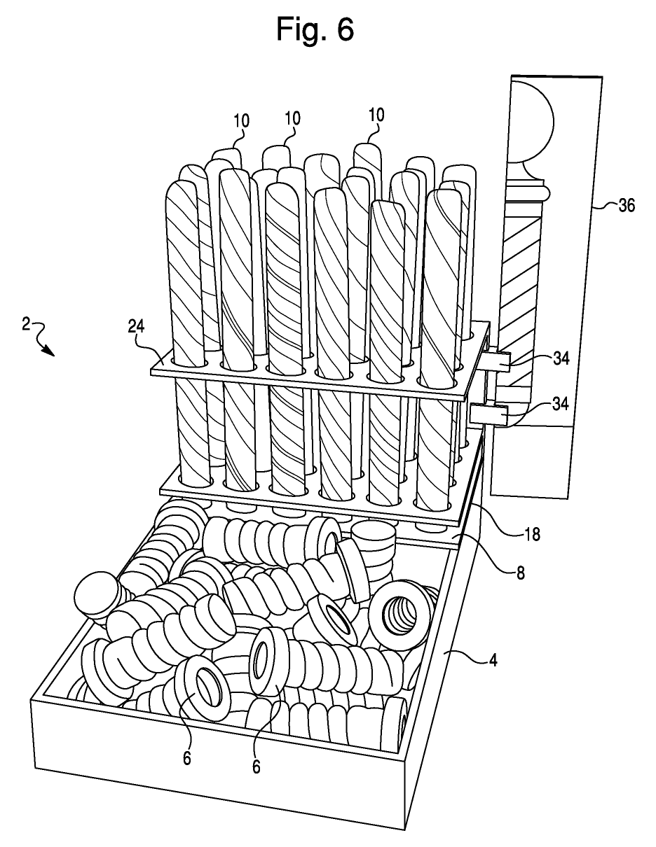

As best shown in FIGS. 1, 2, 4, and 6, a candy display stand 2 includes a tray 4 for keeping candy holders 6 (see FIG. 6) and a support stand 8 for maintaining elongated candy sticks 10 (see FIG. 6). The tray 4 is substantially rectangular with a bottom surface 12 and side surfaces 14 defining a holding area 16 in which a variety of the candy holders 6 can be maintained. Preferably the display stand 2 and its components are formed from a clear or translucent polymeric material in order to permit viewing of the candy and cleaning of the display stand 2. According to an embodiment of the invention, polymethylmethacrylate, also known as acrylic glass and sold commercially as Plexiglas® or Lucite® is a preferred clear or translucent polymeric material. In other embodiments, alternative polymeric materials, such as polypropylene or polyethylene can also be used. In addition, other materials such as glass, wood, paper or metal may also be utilized as materials in non-translucent embodiments according to the invention.

The support stand 8 includes a base 18 and an alignment unit 20. The alignment unit 20 forms a plurality of channels 22 in which elongated candy sticks 10 are vertically supported. To this end, the alignment unit 20 includes an alignment plate 24 with a plurality of upper holes 26 formed therein. The upper holes 26 may also be referred to herein as “holding members.” The upper holes 26 surround the elongated candy sticks 10 to prevent the candy sticks 10 from falling sideways. The alignment plate 24 is supported above the base 18 by at least one vertical support panel. As best shown in FIG. 1, the at least one vertical support panel may be a rear panel 28 of the support stand 8. The rear panel 28 extends upwardly from the base 18 and engages a rear end of the alignment plate 24. The alignment plate 24 and the base 18 define a rectangular area therebetween in which the elongated candy sticks 10 stand. The rear panel 28 may support the alignment plate 24 by itself.

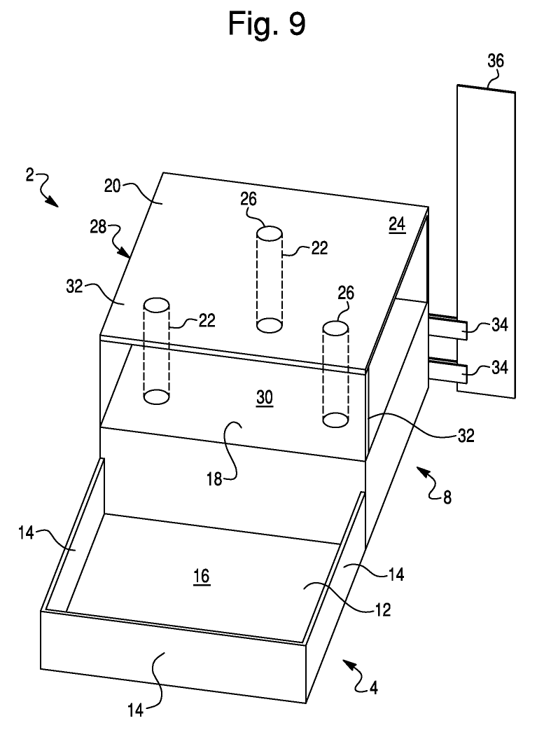

Alternatively, as best shown in FIG. 8, side panels 32 may additionally extend from the base 18 to the alignment plate 24 for support. In yet another embodiment shown in FIG. 9, a front panel 30 may extend between the base 18 and the alignment plate 24 along with the rear panel 28 and the side panels 32. In this case, the rectangular space between the alignment plate 24 and the base 18 is enclosed on all sides.

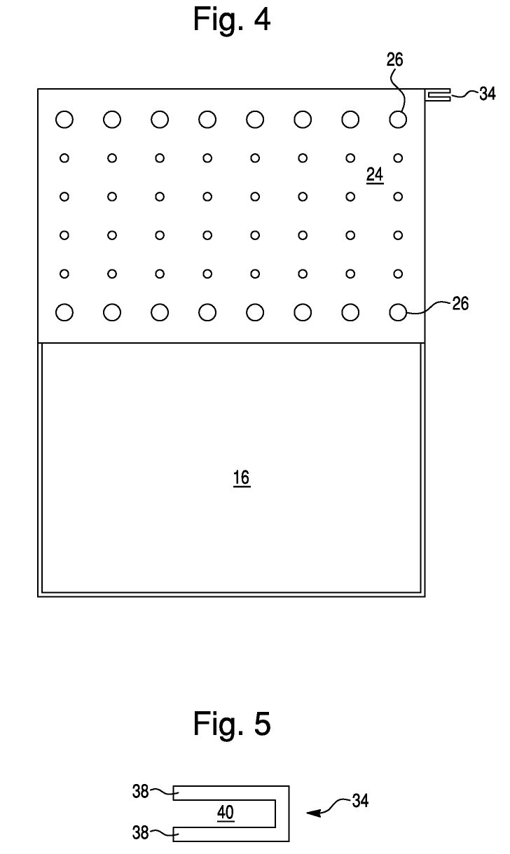

Although only three upper holes 26 are shown in FIGS. 1, 8, and 9, it should be understood that the alignment plate 24 includes a two dimensional array of the upper holes 26 for receiving the candy sticks 10, as best shown in FIG. 4. Preferably, but not necessarily, the number and arrangement of the upper holes 26 is selected to maximize the number of candy sticks 10 that can be vertically supported by the stand 2.

One or more sign clips 34 extend from the rear panel 28 to hold a display sign 36 associated with the elongated candy sticks 10 and the candy holders 6. The clips 34 preferably extend to the side of the rear panel 28, however, it should be understood that the clips 34 can extend upwardly from a rear portion of the alignment plate 24 to hold the sign 36 above the candy display stand 2, instead of to the side of the candy display stand 2.

As best shown in FIG. 5, the clip 34 has two opposing surfaces 38 defining a space 40 therebetween. The space 40 is dimensioned so that the sign 36 can be slidably disposed between the surfaces 38 and held vertically by friction. The sign 36 may be a cardboard cutout portion of the box in which the candy sticks 10 and/or candy holders 6 are shipped.

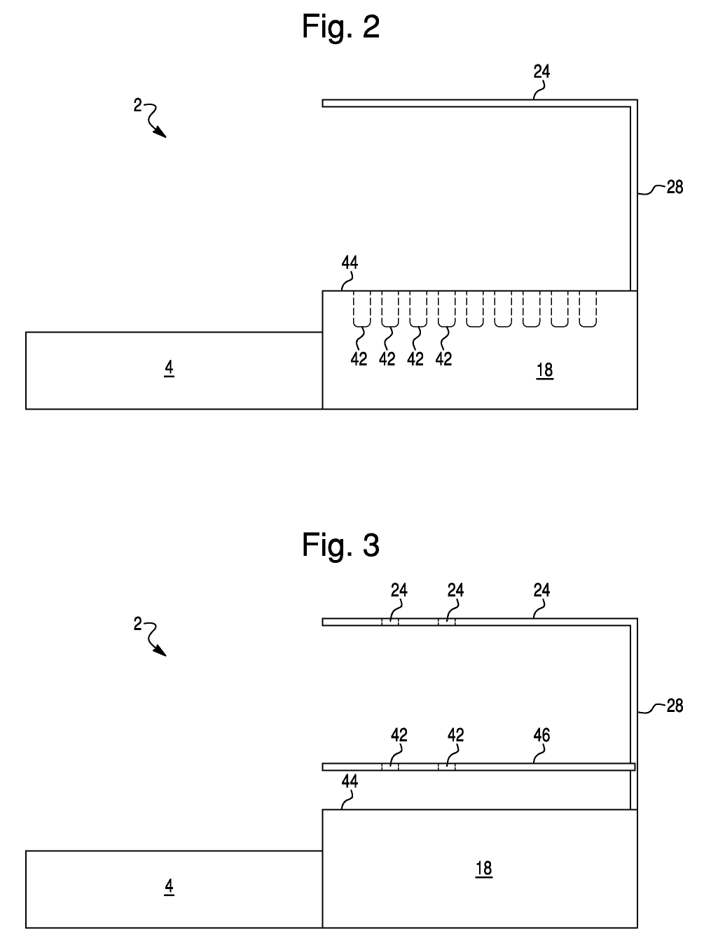

As best shown in FIG. 2, the base 18 may be formed with a plurality of lower holes 42 extending downwardly inward from a top surface 44 of the base 18. The lower holes 42 are aligned with the upper holes 26 of the alignment plate 24, as best shown in FIG. 1, so that the candy sticks 10 (see FIG. 6) are maintained substantially vertically, although other configurations can also be utilized, such as alignments involving a configuration in which the candy sticks 10 form an angular projection that is uniform, but not substantially vertical (not shown). Preferably the diameter of the holes 42 and 26 are the same in order to maintain the vertical orientation of the candy sticks 10. In addition, the lower holes 42 and the upper holes 26 can be coordinated to form regular patterns, such as one or more circles or even random configurations that involves some or all of the candy sticks 10 leaning at different angles or arranged in a desired attractive pattern.

As best shown in FIG. 3, a second alignment plate 46 may be arranged below the alignment plate 24 near the top surface 44 of the base 18. The second alignment plate 46 also includes a plurality of lower holes that are aligned with the upper holes 26 of the alignment plate 24 in order to support the candy sticks 10 vertically. The lower holes 42 formed in the base 18 may be used with or without the second alignment plate 46 shown in FIG. 3. Conversely, the second alignment plate 46 may be used with or without the lower holes 42 formed in the base 18 shown in FIG. 2.

In yet another embodiment, neither the lower holes 42 nor the second alignment plate 46 are included in the candy display stand 2. In this case, the upper holes 26 in the alignment plate 24 are sufficient to maintain the candy sticks 10 vertically supported.

Although the alignment unit 20 is shown as being the alignment plate 24 with upper holes 26, it should be understood that other variations of the alignment unit 20 may alternatively be used. For example, rather than the alignment plate 24, a plurality of alignment members may extend over the base 18 to maintain the candy sticks 10 vertically oriented. In this case, the alignment members may have alignment holes/openings formed therein for receiving the candy sticks 10. Alternatively, the alignment members may be disposed between neighboring rows of the candy sticks 10. In this case, the alignment members may include curved accommodating parts for accommodating the curved outer surface of the candy sticks 10.

As best shown in FIGS. 1 and 6, the candy display stand 2 may be formed of clear plastic so that consumers can view the candy sticks 10 and the candy holders 6 through the stand 2. The tray 4 and the support stand 8 may be formed integrally as for example in a manufacturing operation involving molding, such as injection, extrusion or compression molding to form the while complete candy stand. According to another embodiment, the candy stand may be formed from separate components that are formed separately and then welded or fixed together.

As best shown in FIG. 6, the candy sticks 10 are arranged in the support stand 8 such that the top portions thereof are exposed above the alignment plate 24. Accordingly, a consumer can readily remove the desired candy stick 10 from the stand 2. The candy sticks 10 may include sticks 10 of different colors, swirl designs, and flavors. Additionally, a plurality of different color candy holders 6 may be disposed in the tray 4. Thus, a consumer can select and/or match the candy pole 10 with the desired color, swirl design, and flavor with the candy holder 6 of a specific color.

Because the tray 4 is maintained in close proximity with the support stand 8, the consumer can easily select a candy stick 10 and holder 6. Additionally, because the tray 4 is connected with the support stand 8 to form an integral unit, the candy display stand 2 can be easily relocated to a different location in a retail outlet. The support stand 8, which secures the candy sticks 10 in an upright position, minimizes the possibility of candy sticks 10 falling and/or breaking. The vertical orientation of the candy sticks 10 in the transparent display stand 2 also makes each of the variations in the candy sticks 10 easy to view and/or examine by consumers without removal from the stand 2 when making a selection of a candy pole 10 based on color, swirl design, or flavor. Furthermore, because tray 4 and stand 8 preferably are integral, a consumer is more likely to purchase a holder 6 when purchasing a candy stick 10. Moreover, because tray 4 extends forwardly from stand 8, the holders 6 are easily viewed and selected when a consumer is selecting a candy stick 10.

Although the candy display stand 2 is shown and described above as being rectangular, it should be understood that the base 18, tray 4, and alignment unit 20 of the display stand 2 may be made in other shapes, for example, triangular, circular, hexagonal, etc.

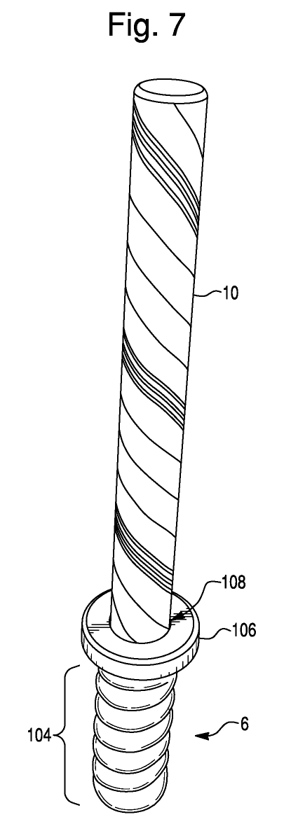

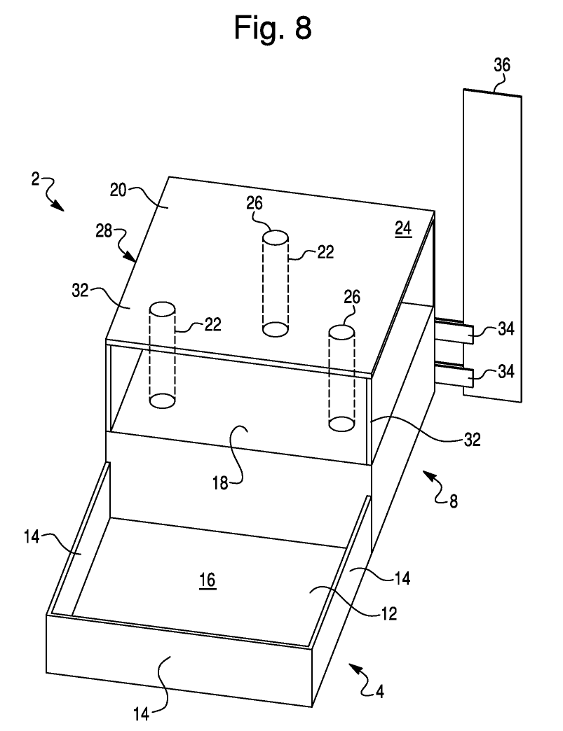

As best shown in FIG. 7, the candy holder 6 includes a handle portion 104 and a top portion 106. The handle portion 4 is grasped by a user's hand while the top portion 106 rests on top of the user's hand. An opening 108 for receiving the elongated candy pole 10 is arranged in the top portion 106. The handle portion 104 and the top portion 106 house a lower part of the elongated candy 10 together while a portion of the elongated candy 10 remains exposed above the top portion 106. The handle and top portions 104 and 106 have shapes that are substantially cylindrical.

The candy holder 6 shown in FIG. 7 is more filly described in co-pending utility patent application Ser. No. 12/412,712 filed Mar. 27, 2009, which claims priority to provisional patent application number 61/040,321, filed Mar. 28, 2008, the disclosures of which are fully incorporated herein by reference.

The foregoing detailed description of the certain exemplary embodiments of the invention has been provided for the purpose of explaining the principles of the invention and its practical application, thereby enabling others skilled in the art to understand the invention for various embodiments and with various modifications as are suited to the particular use contemplated. This description is not intended to be exhaustive or to limit the invention to the precise embodiments disclosed. Although only a few embodiments have been disclosed in detail above, other embodiments are possible and the inventor intends these to be encompassed within this specification and the scope of the appended claims. The specification describes specific examples to accomplish a more general goal that may be accomplished in another way. Modifications and equivalents will be apparent to practitioners skilled in this art and are encompassed within the spirit and scope of the appended claims and their appropriate equivalents. This disclosure is intended to be exemplary, and the claims are intended to cover any modification or alternative which might be predictable to a person having ordinary skill in the art. For example, a candy stand having panel configurations or manufactured using various materials and methods beyond those described above could be used with this invention.

What is claimed is:

1. A candy display stand comprising:
a tray unit having a bottom surface and a plurality of side surfaces extending therefrom and defining a holding area for holding a plurality of candy holders; and
a support structure associated with said tray unit for supporting a plurality of elongated candy sticks, said support structure having a base extending from said tray unit and an alignment unit extending above said base with a plurality of support members for supporting at least one of a plurality of elongated candy sticks on said base.

2. The candy display stand according to claim 1, wherein said support structure is configured to support at least one of said elongated candy sticks in a substantially vertical position perpendicular to said base.

3. The candy display stand according to claim 1, wherein said support structure further includes:
a panel extending upwardly from said base; and
an alignment plate extending from said panel over said base, said alignment plate having a plurality of holes, each of said holes being dimensioned to fit at least one elongated candy stick.

4. The candy display stand according to claim 3, wherein said support structure further includes:
at least one clip arranged to extend outwardly from said panel; and
a sign held by said clip.

5. The candy display stand according to claim 3, wherein said panel extends vertically from said base and said alignment plate extends horizontally from said panel over said base.

6. The candy display stand according to claim 3, wherein said panel extends vertically from said base and said alignment plate extends horizontally from said panel over said base such that said base and said panel are disposed parallel to each other.

7. The candy display stand according to claim 1, comprising a plastic material.

8. The candy display stand according to claim 7, wherein said plastic material is polymethylmethacrylate.

9. The candy display stand according to claim 1, wherein said side surfaces extending from said bottom surface of said tray unit have a side surface length that is less than a height associated with said base.

10. A candy display stand comprising:
a tray unit including a bottom surface and a plurality of side surfaces extending therefrom and defining a holding area;
a plurality of candy holders disposed in said holding area;
a support structure extending laterally from said tray unit, said support structure including:
a base having a plurality of bottom holes disposed at a top surface thereof,
at least one panel extending upwardly from said base, and
an alignment unit extending from said panel over said base, said alignment unit including an alignment plate with a plurality of upper holes, said upper holes being coaxially aligned with said lower holes; and
at least one of a plurality of elongated candy sticks disposed in an aligned pair of said upper and lower holes so that said at least one candy stick extends substantially vertically from said base.

11. The candy display stand according to claim 10, wherein said support structure further includes at least one clip arranged to extend outwardly from said panel.

12. The candy display stand according to claim 11, wherein said support structure further includes a sign held by said clip.

13. The candy display stand according to claim 10, wherein said panel extends vertically from said base and said alignment plate extends horizontally from said panel over said base.

14. The candy display stand according to claim 10, wherein said panel extends vertically from said base and said alignment plate extends horizontally from said panel over said base such that said base and said alignment plate are disposed parallel to each other.

15. The candy display stand according to claim 10, comprising a plastic material.

16. The candy display stand according to claim 15, wherein said plastic material is clear.

17. The candy display stand according to claim 15, wherein said plastic material is polymethylmethacrylate.

18. The candy display stand according to claim 10, wherein said side surfaces extending from said bottom surface of said tray unit have a side surface length that is less than a height associated with said base.

19. The candy display stand of claim 10, wherein said upper and lower holes have a common diameter.

20. A method of manufacturing a candy display stand comprising:
providing an amount of a molding material to a molding apparatus;
performing a molding step on said molding material to form a candy display stand having as structural elements a) a tray unit for holding a plurality of candy holders and b) a support structure associated with said tray unit for supporting a plurality of elongated candy sticks, said support structure having b1) a base extending from said tray unit and b2) an alignment unit extending above said base with a plurality of support members for supporting a plurality of elongated candy sticks on the base; and
removing said candy display stand from said molding apparatus.

21. The method of manufacturing according to claim 19, wherein said molding material is polymethylmethacrylate.

22. A method of using a candy display stand, said method comprising:
selecting a candy holder from a tray unit in a candy stand including a tray unit for holding one or a plurality of candy holders and a support structure associated with the tray unit for supporting a plurality of elongated candy sticks, the support structure having a base extending from the tray unit and an alignment unit extending above the base with a plurality of support members for supporting a plurality of elongated candy sticks on the base;
selecting an elongated candy stick from the support structure; and
inserting the selected elongated candy stick into the selected candy holder.
